(19) United States
(12) Patent Application Publication
(10) Pub. No.: US 2006/0239904 A1
(43) Pub. Date: Oct. 26, 2006

(54) Utilization of lead shavings in abrasion mills for the production of lead oxide

(76) Inventors: Armando Marfisi, Lanciano (IT); Fernando Marfisi, Lanciano (IT); Bruno Marfisi, Lanciano (IT)

Correspondence Address: LEFFERT JAY & POLGLAZE, P.A., P.O. BOX 581009, MINNEAPOLIS, MN, 55458-1009, US

(21) Appl. No.: 10/566,459

(22) PCT Filed: Jun. 7, 2004
(86) PCT No.: PCT/IT04/00328

§ 371 Date: Jan. 30, 2006

(30) Foreign Application Priority Data
Jul. 30, 2003 (IT) CH2003A000013

(51) Int. Cl. C01G 21/02

(52) U.S. Cl. 423/620

(57) ABSTRACT

Abrasion mills for the production of lead oxide call for the use of mechanically produced lead shavings, taken directly from bars or other adequately titrated lead bars. The flat, helical lead shavings are produced using specially designed equipment. The compression and release of the material produces a press and pull action which stresses the surface, making it rough and subject to flaking. The mechanical compression favors hardening of the surface of the shaving, thus increasing abrasion inside the mill. These shavings are therefore ready for immediate use in the mill, with no need for aging.

### TECHNICAL FIELD

Abrasion mills for the production of lead oxide, like those utilized in the energy storage industry, function through the utilization of lead elements which are adequately titrated according to the oxidation process for which the mill has been created.

The lead used is produced in titration and ingot—producing pots. The ingots are then transformed into elements of different shapes and dimensions for use in the mills. The shape, size, molecular structure and the other chemical—physical properties of the lead elements put into the mills, and which make up the “ballast” are fundamental for the good results of the oxidation process, and for the overall cost of the oxide production process.

### BACKGROUND ART

Through the years, the production of material to be used in abrasion mills has undergone an evolution which has led to several different solutions.

At first ingots of pure material were used to feed these mills. Although this technique reduces the number of passages to a minimum, it presents numerous disadvantages from the point of view of oxidation process control and yield. Oxidation is a superficial process, and the external surface—volume ratio of the ingots is low. Moreover, this method does not favor the passage of air through the mill ballast during the oxidation phase, thus reducing the yield of the process.

An important step was made when the ingots were broken down into portions (4, 5 pieces). This intermediate method was an improvement on the first, but maintained the same problems.

Many mills utilize a more complex technique with the aim of optimizing the raw materials, although the plant costs considerably more to build and run. The pure lead bars are melted again, molded into cylinders, cooled and matured before being loaded into the mill. This method produces a higher yield of oxide but has created the following serious complications in the system:

Higher costs for the slug casting machine; higher costs for personnel to run these machines;

Higher running costs for safety and management of another lead melting plant;

Higher costs of conveyor systems for high temperature materials;

More space needed for storage areas preceding the mill area;

Production and management of waste in the slug casting melt pots with a waste of material and problems for its management, re-utilization and elimination;

Need to plan production in consideration of the great amount of time needed for start up and shut down of the melt pots for the slug casters;

### DISCLOSURE OF INVENTION, BEST MODE FOR CARRYING OUT AND INDUSTRIAL APPLICABILITY

Abrasion mills for the production of lead oxide call for the use of mechanically produced lead shavings, formed directly from ingots or other adequately titrated lead bars. The flat, helical lead shavings are formed by specially designed machinery and are considerably smaller than the other two types. The mechanical compression and release action carried out by the machine on the cut material produces a press and pull action which stresses the surface, making it rough and subject to flaking. The mechanical compression favors hardening of the surface of the shaving. These shavings are therefore ready for immediate use inside the mill, with no need for aging.

By virtue of the shape, size and molecular structure, these shavings increase the yield of the oxidation process inside the mill for the following reasons:

The flat shape increases the external surface—volume ratio, exposing as much material as possible to oxidation and reducing the thermal gradient between the outer and inner areas of each single shaving.

The helical shape favors the passage of air through the ballast inside the mill, increasing the surface exposed to oxidation and enhancing uniformity of the temperature through the ballast. This second element improves process control and thus increases the quality of the oxide produced, reducing the risk of overheating and the consequent formation of orthorhombic oxide (Massicot).

The hardening of the shavings' surface increases the abrasion coefficient in the mill ballast, enhancing the heat generated by the abrasion, which is fundamental to the oxidation reaction.

The stressed surface of the shaving tends to flake and release micro-flakes during the rotation of the ballast in the mill, which rapidly offer another surface to the oxidation process.

Another advantage is that abrasion mills fed with shavings for lead oxide production drastically simplify the process system antecedent to the mills and the relative running in the following way:

The mechanical production of the shaving is quick and waste-free, as opposed to fusion processes like slug casters, which produce a great quantity of waste but require ad hoc storage, re-use or waste processing systems, due to the particular nature of the material.

The shavings do not need to be stored or aged before using in the mill, thus reducing the volume of the intermediate storage areas and the need to plan and balance production for the line.

The shavings do not undergo thermal treatment which would change the composition of the previously titrated material, thus assuring the quality of the ballast inside the mill.

Shavings can be produced using simple machinery, low cost and low running costs in terms of number and qualification of the personnel running it.

The machinery for producing these shavings is utilizable immediately on the basis of the material needed to feed the mill, because they practically do not need long start up or shut down operations.

The use of machinery for producing shavings reduces safety and environmental risks and requirements to a minimum (high temperatures, risk of fire, harmful vapors), increases hourly productivity, in particular as compared to the slug casters used at present, which require the fusion of lead.

1) Utilization of lead shavings removed from lead bars by means of cutting machinery in abrasion mills for the production of lead oxide.
The process is extremely simple.

2) Utilization of lead shavings removed from lead bars for the production of lead oxide, as claimed in claim (1), characterized by the use of shavings having a flat, helical shape.
This particular shape is advantageous for the control and yield of the oxidation process.

3) Utilization of lead shavings removed from lead bars for the production of lead oxide, as claimed in the preceding claims, characterized by the use of shavings with a surface which has been stressed by the cut and subject to flaking.
The release of micro-flakes of material increases yield during the oxidation process, providing a greater surface for the reaction.

4) Utilization of lead shavings removed from lead bars for the production of lead oxide, as claimed in the preceding claims, characterized by the use of shavings with a hardened surface, due to the effect of the cutting action.
The hardened parts favor abrasion, which constitutes the main principle of the functioning of these mills.
